(19) United States
(12) Patent Application Publication
(10) Pub. No.: US 2023/0240486 A1
(43) Pub. Date: Aug. 3, 2023

(54) BUSSOM BOTTOM

(71) Applicants: Mario Gudino, Lancaster, CA (US); Alexander Gudino, Lancaster, CA (US)

(72) Inventors: Mario Gudino, Lancaster, CA (US); Alexander Gudino, Lancaster, CA (US)

(21) Appl. No.: 17/588,284

(22) Filed: Jan. 30, 2022

(51) Int. Cl. A47K 13/30; H05B 1/02; F21V 33/00

(52) U.S. Cl. CPC A47K 13/305; H05B 1/0252; F21V 33/004; H05B 1/0202

(57) ABSTRACT

A heating system for a toilet seat for warming the toilet seat is presented. The heating system is useful for providing a comfortable warm seat for a user when they are using a toilet. Also, the heating system is useful for providing a lighted guide of the toilet for the user.

### FIELD OF THE INVENTION

This invention relates to toilets. More particularly, it relates to heating and lighting a seat for a toilet.

### BACKGROUND

A toilet is a piece of sanitary hardware that collects human urine and feces, and sometimes toilet paper, usually for disposal. Flush toilets use water, while dry or non-flush toilets do not. They can be designed for a sitting position popular in North America with a toilet seat, with additional considerations for those with disabilities. In urban areas, flush toilets are usually connected to a sewer system that leads to septic tanks in isolated areas. The waste k known as blackwater and the combined effluent including other sources is sewage. Dry toilets are connected to a pit, removable container, composting chamber, or other storage and treatment device, including urine diversion with a urine-diverting toilet.

The technology used for modern toilets varies. Toilets are commonly made of ceramic (porcelain), concrete, plastic, or wood. Newer toilet technologies include dual flushing, low flushing, toilet seat warming, self-cleaning, female urinals and waterless urinals. Japan is known for its toilet technology. Airplane toilets are specially designed to operate in the air. The need to maintain anal hygiene post-defecation is universally recognized and toilet paper (often held by a toilet roll holder), which may also be used to wipe the vulva after urination, is widely used (as well as bidets).

In private homes, depending on the region and style, the toilet may exist in the same bathroom as the sink, bath, and shower. Another option is to have one room for body washing (also called “bathroom”) and a separate one for the toilet and handwashing sink (toilet room). Public toilets (restrooms) consist of one or more toilets (and commonly single urinals or trough urinals) which are available for use by the general public. Products like urinal blocks and toilet blocks help maintain the smell and cleanliness of toilets. Toilet seat covers are sometimes used. Portable toilets (frequently chemical “porta johns”) may be brought in for large and temporary gatherings.

One issue that arises is that toilet seats are known to be cold as they don't keep heat nor do the toilet seats have a heating mechanism to allow for a comfortable experience for a user. Another issue that arises is that when it is a dark condition, the toilet seat is not visible to the user.

In light of the foregoing, it would be desirable to devise an improved toilet device that provided for a heating of the toilet seat for a more comfortable experience for the user. It would be further advantageous if the device were more to be lit such that the user has knowledge of the location of the toilet seat when no lights are on and the user is in need of using the toilet at night.

### BRIEF DESCRIPTION OF THE DRAWINGS

FIG. 1 is an illustrated view of a heating device.

FIG. 2 is an illustrated view of an inside surface of the toilet seat shown in FIG. 1.

FIG. 3 is an illustrated view of the toilet seat shown in FIG. 1 with a toilet seat in a down position.

FIG. 4 is an illustrated view of the toilet seat and the heating device shown in FIG. 1 with a lighting device.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

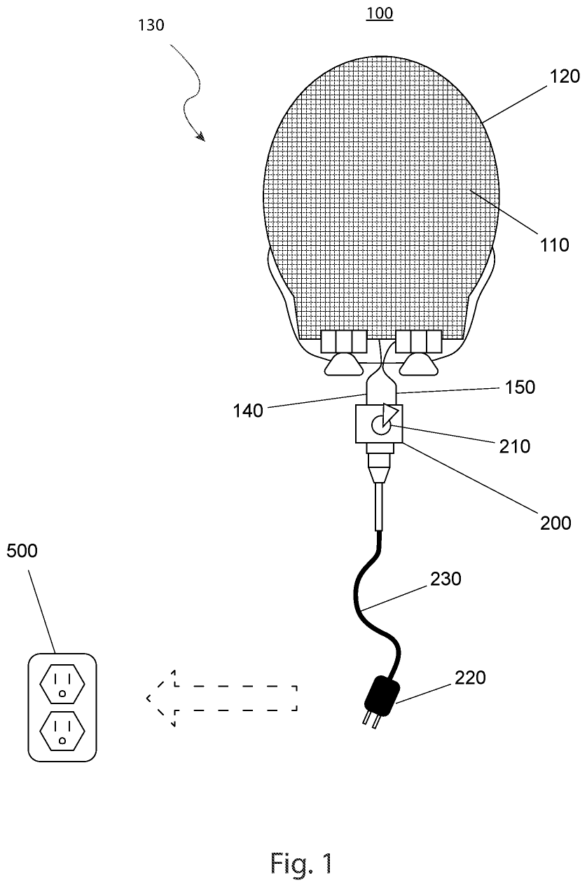

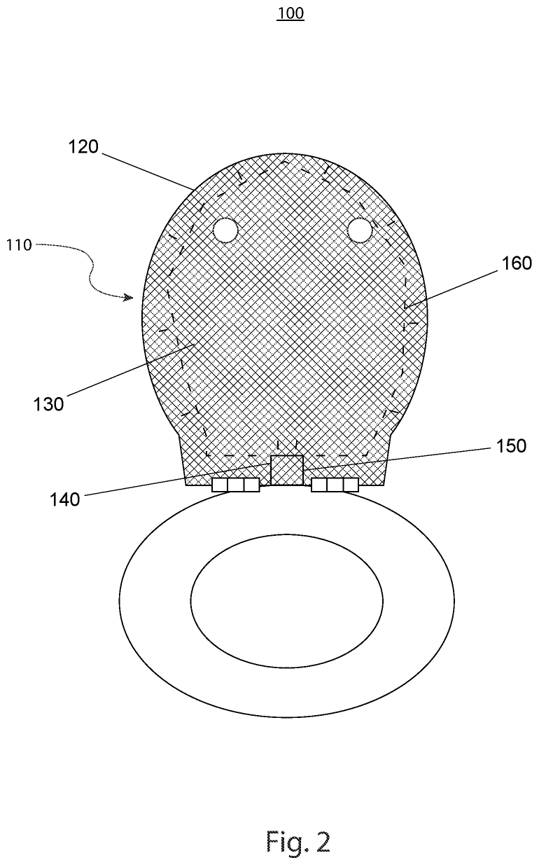

Referring to FIG. 1 and FIG. 2, a heating system 100 for a toilet seat 300 for warming the toilet seat 300 is presented. The heating system 100 is useful for providing a comfortable warm seat for a user when they are using a toilet 400. Also, the heating system 100 is useful for providing a lighted guide of the toilet 400 for the user.

The heating device 100 is preferably oval in shape, however other shapes are hereby contemplated, including, but not limited to, round, oblong, etc. The heating device 100 preferably is made of a heat resistant material, however other materials are hereby contemplated, including, but not limited to, cotton, flannel, etc.

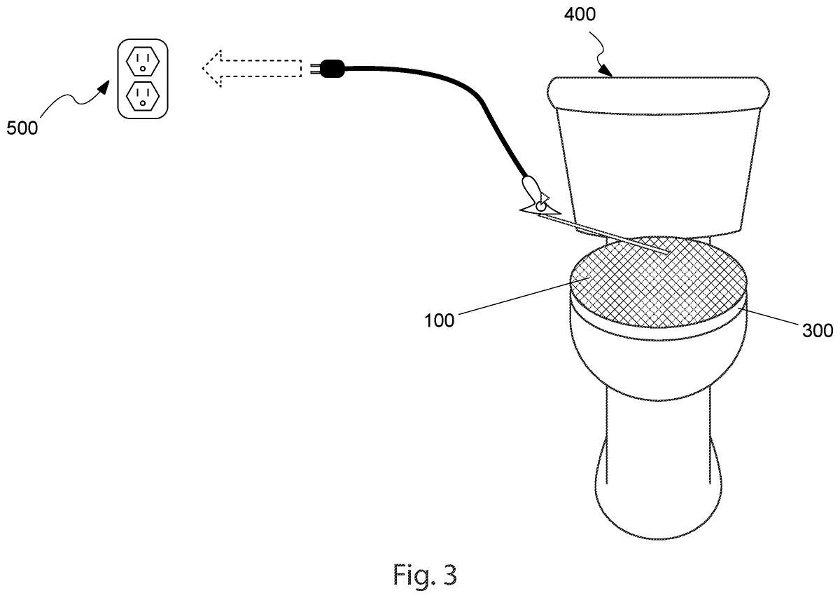

The heating device 100 has a top 110, a side 120 and a bottom 130. The side 120 of the heating device 100 fits around the toilet seat 300, shown in FIG. 3. One or more electrical wires 140, 150 are coupled to one or more heating elements 160, shown in FIG. 2. The electrical wires 140, 150 are coupled to a converter/controller 200. The converter/controller 200 allows for an electrical current to be converted for use with the heating elements 160. This may include stepping the voltage down from 120 volts to 12 volts as required for the heating elements 160. The converter/controller 200 has a control switch 210. The control switch 210 is preferably a toggle switch, however other switches are hereby contemplated, including, but not limited to, a panel, a button, etc.

The converter/controller 200 is coupled to an electrical plug 220 by an electric cord 230. The electrical plug 220 is removably coupled to an electrical outlet 500 for providing a power source.

When the control switch 210 is in an on position, electrical current from the electric outlet 500 is supplied to the heating elements 160 and the heating elements 160 emit a heat to the bottom 130 of the heating device 100 thus providing a heat to the toilet seat 300. When the control switch 210 is in an off position, electrical current from the electric outlet 500 is stopped from being transmitted to the heating elements 160 and the heating elements 160 do not heat to the bottom 130 of the heating device 100.

Moving now to FIG. 3, the heating device 100 is coupled to the toilet seat 300, which in turn is coupled to a toilet 400. The heating device 100 is plugged into the electrical outlet and is prepared to provide heat to the toilet seat.

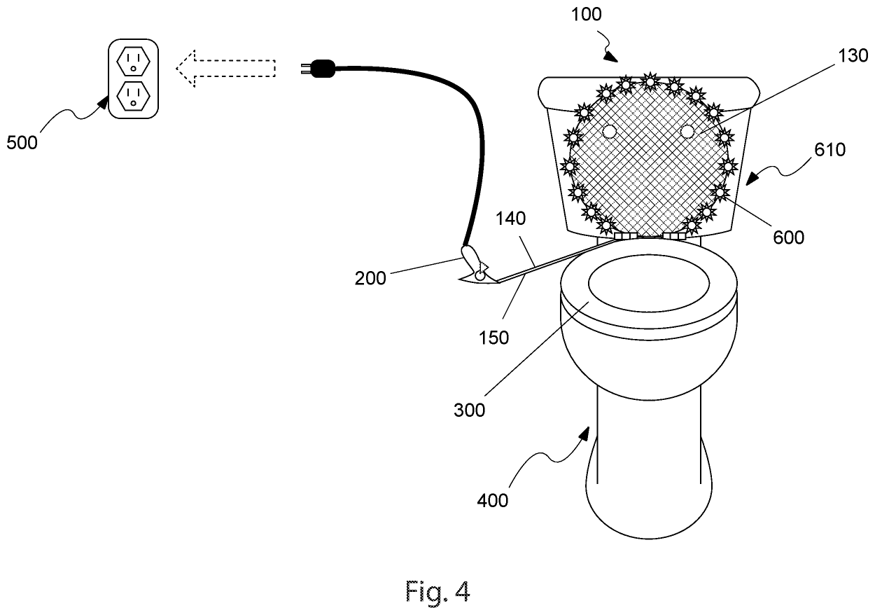

Now referring to FIG. 4, the bottom 130 of the heating device 100 is shown when it is coupled to the toilet seat 300 which in turn is coupled to the toilet 400. The heating device 100 is plugged into the electrical outlet 500 and ready for use.

Alternatively, and or additionally, the heating device 100 has a plurality of lights 600 coupled to the converter/controller 200 by the electrical wires 140, 150. The lights 600 emit a light 610 for providing an outline or illumination of the toilet seat 300 and the toilet 400. The lights 600 are preferably light emitting diodes (LEDs), however it is hereby contemplated that any type of desired lights may be used.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A heating device for providing a warm toilet seat for a user, the heating device comprising:
a top;
a bottom, the bottom being removably coupled to a toilet seat, the bottom having one or more heating elements;
a side, the side extending from the top, the side being securely and removably coupled to the toilet seat;
one or more electrical wires, the electrical wires coupled to a back of the heating device;
a converter/controller device, the converter/controller device having a control switch, the converter/controller coupled to the electrical wires, the converter/controller being coupled to an electrical cord;
an electric plug, the electrical plug being coupled to the electric cord and the electric plug being removably coupled to an electric outlet.

2. The heating device of claim 1, wherein the heating device being made of a heat resistant material.

3. The heating device of claim 1, wherein the heating device having an oval shape.

4. The heating device of claim 1, wherein the converter/controller providing a conversion of an electrical current received from the electric outlet, wherein the converted electrical current being sent to the heating device.

5. The heating device of claim 1, wherein converter/controller having a toggle switch for controlling the electrical current being sent to the heating device.

6. The heating device of claim 1, further comprising: the bottom of the heating device having one or more lights, the lights being coupled to the electrical wires, and wherein the lights being illuminated to have the toilet visible in a dark condition.
